(19) United States
(12) Patent Application Publication
(10) Pub. No.: US 2010/0007974 A1
(43) Pub. Date: Jan. 14, 2010

(54) Auxiliary side view mirror

(76) Inventor: Peng-Kai Chuang, ChangHua Hsien (TW)

Correspondence Address: QUINN EMANUEL;KODA & ANDROLIA, 865 S. FIGUEROA STREET, 10TH FLOOR, LOS ANGELES, CA, 90017, US

(21) Appl. No.: 12/069,538

(22) Filed: Feb. 11, 2008

(51) Int. Cl. B60R 1/078; G02B 5/08

(52) U.S. Cl. 359/850; 359/865

(57) ABSTRACT

An auxiliary side view mirror for attaching to an existing side view mirror of a motor vehicle. This auxiliary side view mirror includes a housing. The housing has an auxiliary mirror portion and a side view mirror interior housing adjacent the auxiliary mirror portion. The auxiliary mirror portion contains an auxiliary mirror and the side view mirror interior housing has an opening and an interior shape, size and contour corresponding to an exterior shape, size and contour of the existing side view mirror of the vehicle whereby the existing side view mirror of the motor vehicle fits within the side view mirror interior housing of the housing through the opening. A plurality of tabs are provided around the opening and the tabs extend towards the interior of the opening. Accordingly, the auxiliary side view mirror is mounted on the existing side view mirror of the motor vehicle by simply inserting the existing side view mirror into the opening in the side view mirror interior housing and engaging the plurality of flexible tabs with the existing side view mirror.

### BACKGROUND OF THE INVENTION

1. Field of Invention

The present invention relates to a side view mirror for a motor vehicle and more particularly to an auxiliary side view mirror for being removably attached to the housing of an existing side view mirror for extending the viewing area of the side view mirror, particularly during the towing of a trailer.

2. Prior Art

In the Prior Art there exists auxiliary side view mirrors. However, these auxiliary side view mirrors have various disadvantages. These disadvantages include but are not limited to the fact that they are not aesthetically pleasing in their appearance when mounted on a motor vehicle, include complex mechanisms which are easily broken or lost and require additional mounting hardware which is not integral with the auxiliary mirror. Examples of such prior devices are found in U.S. Pat. Nos.:
U.S. Pat. No. 3,954,328
U.S. Pat. No. 4,892,401
U.S. Pat. No. 5,296,973

### SUMMARY OF THE INVENTION

Accordingly, it is the general logics of the current invention to provide an auxiliary side view mirror which overcomes the disadvantages of the Prior Art.

In particular, it is an object of the present invention to provide an auxiliary side view mirror which is easy to attach, requires no additional parts and is esthetically pleasing.

In keeping with the principles of the present invention, the objects are accomplished by an auxiliary side view mirror for attaching to an existing side view mirror of a motor vehicle. This auxiliary side view mirror includes a housing. The housing has an auxiliary mirror portion and a side view mirror interior housing adjacent the auxiliary mirror portion. The auxiliary mirror portion contains an auxiliary mirror and the side view mirror interior housing has an opening and an interior shape, size and contour corresponding to an exterior shape, size and contour of the existing side view mirror of the vehicle whereby the existing side view mirror of the motor vehicle fits within the side view mirror interior housing of the housing through the opening. A plurality of tabs are provided around the opening and the tabs extend towards the interior of the opening and are for engaging with the existing side view mirror which exists on the motor vehicle. Accordingly, the auxiliary side view mirror is mounted on the existing side view mirror of the motor vehicle by simply inserting the existing side view mirror into the opening in the side view mirror interior housing and engaging the plurality of flexible tabs with the existing side view mirror.

In addition, the exterior of the housing is designed such that it looks substantially like the existing side view mirror in its contours and shapes and can be painted a color or manufactured in a color which matches the color or provides an aesthetic contrast to the color of the motor vehicle.

### BRIEF DESCRIPTION OF THE DRAWINGS

The above-mentioned features and objects will be described in the following paragraphs taken in conjunction with the accompanying drawings wherein like referenced numerals do not like elements and in which:

FIG. 1 is a front view of a motor vehicle illustrating the existing side view mirrors;

FIG. 2 is a rear view of a motor vehicle showing the existing side view mirrors;

FIG. 3 is an enlarged partial view of the front of an existing side view mirror;

FIG. 4 is a rear view of an enlarged existing side view mirror;

FIG. 5 is a top view an auxiliary rear view mirror of the present invention with the contours thereof shown in solid lines;

FIG. 6 is a rear view of an auxiliary rear view mirror in accordance with the teachings of the present invention showing the contours in solid lines;

FIG. 7 is a motor vehicle with the auxiliary rear view mirrors of the present invention installed;

FIG. 8 is an enlarged view illustrating the installation of the auxiliary side view mirror of the present invention.

### DETAILED DESCRIPTION OF THE INVENTION

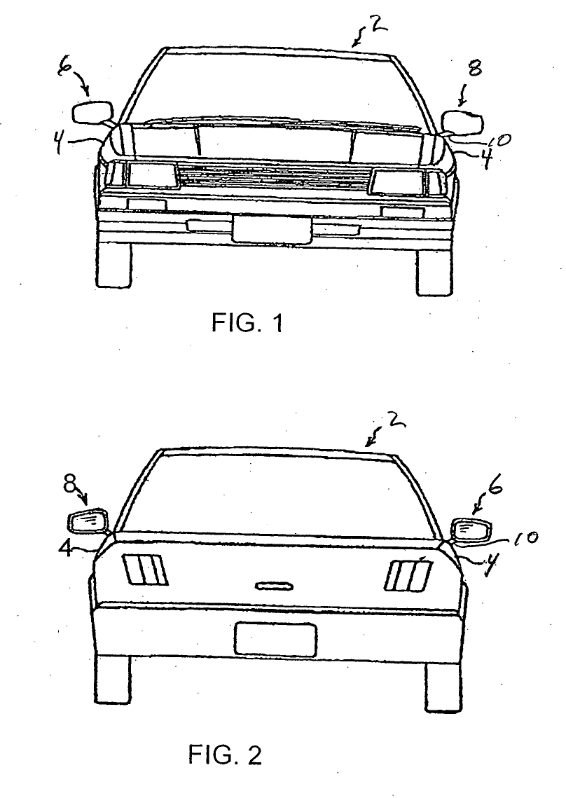

Referring to FIGS. 1 and 2, shown therein is a motor vehicle too with left and right side existing side view mirrors 6 and 8 attached to the body 4 of the motor vehicle 2. The left and right side view mirrors 6 and 8 are connected to the body 4 by means of connecting portion 10.

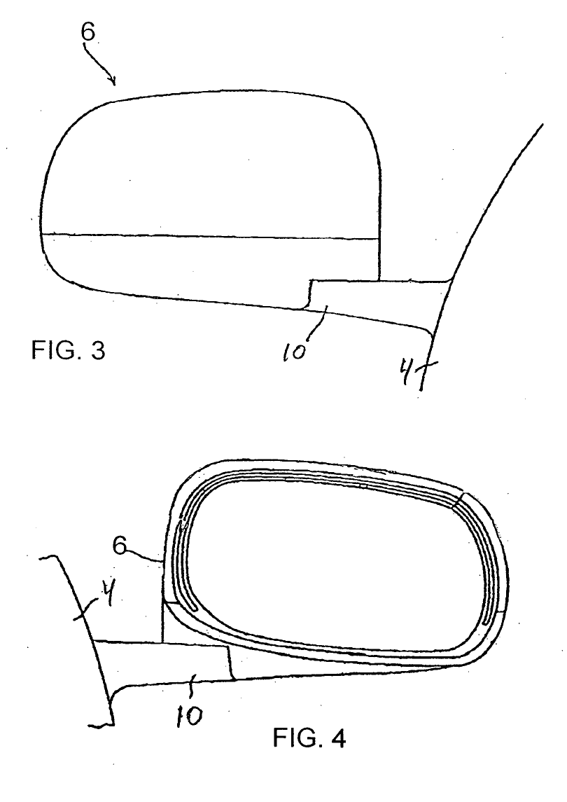

Also referring to FIGS. 3 and 4, shown therein is the left existing side view mirror 6 attached to the body 4 by means of the connecting portion 10. Typically the connecting portion 10 is coupled to the existing side view mirror 6 such that the existing side view mirror 6 can be moved relative to the connecting portion 10, particularly if there is a significant impact to the existing side view mirror 6.

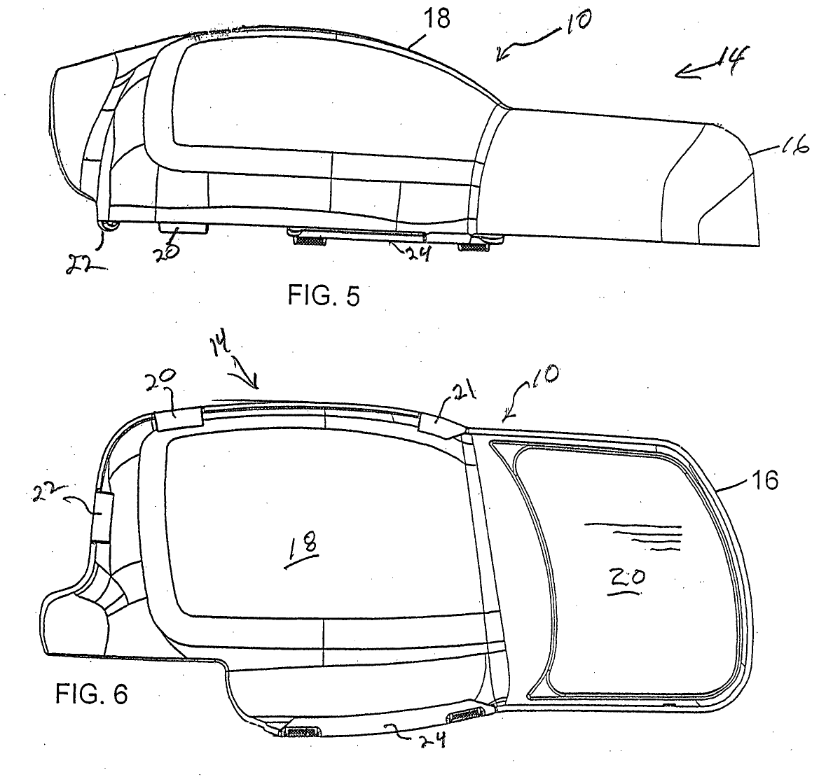

Referring to FIGS. 5 and 6, shown therein is a top and rear view of an auxiliary side view mirror of the present invention. In particular, shown therein is a left side auxiliary side view mirror 10, however the right side auxiliary side view mirror 12 would be a mirror image thereof. The left side auxiliary side view mirror 10 includes a housing 14 generally divided into two portions, namely an auxiliary mirror portion 16 and a side view mirror interior housing portion 18 provided adjacent the auxiliary mirror portion 16. An auxiliary mirror 20 is provided in the auxiliary mirror portion 16 of the housing 14.

The side view mirror interior housing portion 18 has an interior contour shape and size corresponding to the exterior of the existing left hand side view mirror 6 and is configured such that the left hand side view mirror 6 fits snuggly inside of the side view mirror portion 18. Upper, side and lower mounting tabs 21, 22 and 24 are provided around the opening in the side view mirror interior housing 18 and extend generally from the side of the opening to the interior portion of the side view mirror interior housing portion 18. In addition, the tabs 21, 22 and 24 are made from a flexible material and are formed integrally with the housing 14. Also, the entire housing of the auxiliary side view mirror 10, except for the mirror 20, is formed integrally from a single material and the material selected is generally a resin such as a flexible plastic. The flexible plastic is preferably thermal plastic which can be injection molded.

Still further, the exterior of the housing 14 can be formed in a pleasing shape which either conforms to the existing contours of the motor vehicle 2 onto which it is to be mounted or can be made in a shape which is drastically different so as to accentuate or decorate the motor vehicle 2. In addition, the housing 14 can be painted in colors or manufactured in colors which match the existing colors of the motor vehicle 2 or again act as a color accent. It should be apparent to one skilled in the art that if the auxiliary side view mirrors of the present invention were made for existing vehicles such as trucks, namely Ford F-150, Chevrolet Sierra and Dodge RAM, in the manufacturing process, the auxiliary side view mirrors could be made in colors to match or contrast the existing colors of the vehicles.

It should be apparent to one of ordinary skill that one or more thin pads made of a soft compressible material such as sponge could be provided with the side view mirror interior housing portion is to present damage to the existing side view mirror 6 and 8. Also, if the auxiliary side view mirror 10 is made from a material which is not paintable such as polypropylene, it can be molded into various colors to match the exterior color of vehicles. Still further, in some construction the mirror 20 can be provided in the auxiliary mirror portion 16 in a manner known in the art so that it is adjustable.

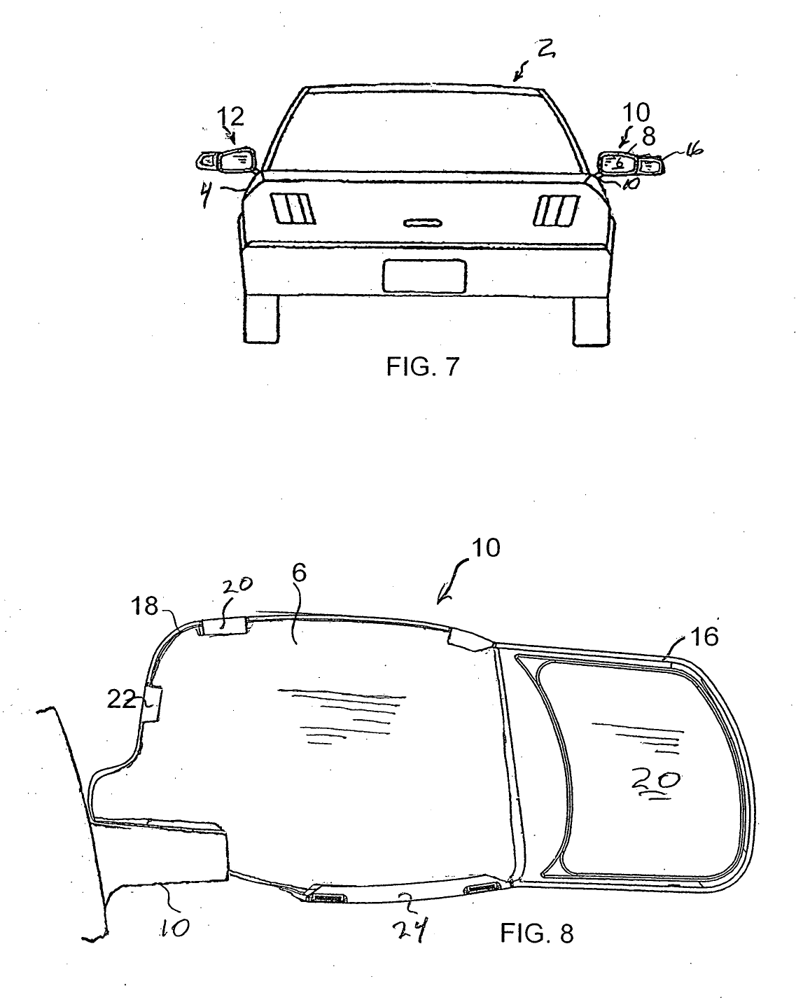

Referring to FIGS. 7 and 8, shown therein is an auxiliary side view mirror in accordance with the teachings of the present invention attached to the existing side view mirrors 6 and 8 of a motor vehicle 2. To perform this attachment, the existing side view mirror 6 is inserted into the opening of the auxiliary side view mirror interior housing portion 18. While being inserted into the side view mirror interior housing portion 18, the tabs 20, 22 and 24 are bent and after the insertion is completed, the tabs 20, 22 and 24 engage with the existing side view mirror 6 and hold it in place. Also, since the interior of the side view mirror interior housing portion has a size, shape and contour which closely approximates the exterior size, shape and contour of the existing mirror 6, the existing mirror 6 fits snuggly within the side view mirror interior housing portion and is held snuggly therein by the shape of the side view mirror interior portion and the tabs 20, 22 and 24.

It should also be apparent from the figures that the connecting portion 10 for the mirror 6 is not impeded and therefore the function thereof, namely the existing side view mirror 6 being able to be moved relative to the connecting portion 10, is not impeded and its safety function continues to exist. Also because of the appearance of the auxiliary side view mirror of the present invention, an aesthetic appearance which matches not only the shape, contours, design sense of the owner and the color of the vehicle is provided which provides an aesthetic appearance.

Should be apparent to one of ordinary skill that the above-described embodiment is merely illustrative of one embodiment of the present invention and numerous and other arrangements can be readily provided without departing from the spirit and scope of the invention.

1. An auxiliary side view mirror for attaching to an existing side view mirror of a vehicle, the auxiliary side view mirror comprises:
a housing, said housing having an auxiliary mirror portion and a side view mirror interior housing portion adjacent said auxiliary mirror portion, said auxiliary mirror portion containing an auxiliary mirror and said side view mirror interior housing portion having an opening and an interior shape, size and contour corresponding to a shape, size and contour of said existing side view mirror of the vehicle whereby said existing side view mirror of the vehicle fits within said side view mirror interior housing portion of the housing through said opening, and
a plurality of tabs provided around said opening, said tabs being flexible and extending transversely to said opening towards an interior of said opening for engaging with said existing side view mirror,
whereby said auxiliary side view mirror is mounted on said existing side view mirror of said vehicle by simply inserting said existing side view mirror into said side view mirror interior housing through said opening and engaging said plurality of flexible tabs with said existing side view mirror.

2. The auxiliary side view mirror according to claim 1 wherein said housing and tabs are integrally formed.

3. An auxiliary side view mirror according to claim 2 wherein said housing and tabs are made from a flexible resin material.

4. The auxiliary side view mirror according to claim 3 wherein the vehicle is an automobile or a truck.
